(19) United States
(12) Patent Application Publication
(10) Pub. No.: US 2011/0111285 A1
(43) Pub. Date: May 12, 2011

(54) ASSEMBLED SEALING MEMBER AND BATTERY USING THE SAME

(76) Inventor: Yasushi Hirakawa, Osaka (JP)

(21) Appl. No.: 13/000,969

(22) PCT Filed: Apr. 14, 2010
(86) PCT No.: PCT/JP2010/002694

§ 371 Date: Dec. 22, 2010

(30) Foreign Application Priority Data
Apr. 27, 2009 (JP) 2009107955

(51) Int. Cl. H01M 2/02

(52) U.S. Cl. 429/178

(57) ABSTRACT

The present invention relates to an improvement to an assembled sealing member used for batteries. The present invention intends to reliably stop charging and discharging particularly in a battery with high capacity and high output performance, when a trouble occurs in the battery. An assembled sealing member for a battery according to one embodiment of the present invention includes: (i) a conductive cap having an external terminal; (ii) an electrically conductive film disposed so as to face a power generation element and being connected to one of electrodes included in the power generation element; (iii) an electrically conductive valving member disposed between the cap and an electrically conductive film; and (iv) a thermally expandable material disposed between the valving member and the electrically conductive film. The electrically conductive film and the valving member are bonded to each other in an electrically connected state at least one predetermined point, and when the thermally expandable material is expanded to be predetermined times larger, the bond between the electrically conductive film and the valving member ruptures to break the electrical connection between the electrically conductive film and the valving member.

### RELATED APPLICATIONS

This application is the U.S. National Phase under 35 U.S.C. §371 of International Application No. PCT/JP2010/002694, filed on Apr. 14, 2010, which in turn claims the benefit of Japanese Application No. 2009-107955, filed on Apr. 27, 2009, the disclosures of which Applications are incorporated by reference herein.

### TECHNICAL FIELD

The present invention relates to batteries, and specifically relates to an improvement to an assembled sealing member used for batteries.

### BACKGROUND ART

Various types of batteries are known. For example, lithium secondary batteries are typically known as batteries for use in small-sized household appliances. Lithium secondary batteries are usable at room temperature, have a high operating voltage and high energy density, and exhibit excellent cycle characteristics. For this reason, lithium secondary batteries are widely used as, for example, a power source for portable small-sized electronic devices such as cellular phones, personal digital assistants (PDAs), notebook personal computers, and video cameras. In recent years, with improvement in performance of portable electronic devices, there is an increasing demand for further improvement in performance of batteries used as a power source therefor.

On the other hand, large-sized batteries are used for power storage or for motor driving for electric vehicles such as hybrid electric vehicles and plug-in hybrid electric vehicles. In particular, the above batteries used as a power source for electric vehicles are required to have a high capacity and further required to be excellent in high output performance.

As described above, there is strong demand for batteries to have improved performance. However, in case of improvement of the battery performance, when a trouble such as short circuiting occurs, the internal pressure of the battery tends to increase due to the gas generated by decomposition of electrolyte, although depending on the configuration or the like of the battery. Further, the temperature of the battery may abruptly increase due to the trouble. Therefore, countermeasures to further improve the battery safety are required.

Conventionally, various proposals have been made to further improve the safety of batteries. For example, Patent Literature 1 discloses a current shut-off device that operates in response to the pressure inside a battery, the current shut-off device being provided on a sealing plate at a place where it will not come in contact with electrolyte or its vapor or decomposition gas. Patent Literature 1 intends to prevent a battery from catching fire or exploding, even if the internal pressure of the battery is increased when overcharged or overdischarged.

Patent Literature 2 discloses a sealing plate provided with a current shut-off lead. Even when the electrolyte is decomposed to generate flammable gas, a valving film provided on the sealing plate works to separate the current shut-off lead from the atmosphere containing the flammable gas. Patent Literature 2 intends to prevent a battery from exploding, or the flammable gas generated inside the battery from being ignited by shutting off the current, in the event of overcharging or short-circuiting.

Patent Literature 3 discloses a safety device including a partition wall that moves toward the outside of a battery case as the internal pressure of the battery case increases, a conductor for electrically connecting a battery reaction portion and a terminal, and a blade being supported on the partition wall so as to cut the conductor. Patent Literature 3 intends to reliably break the current path and to prevent the vapor or decomposition gas of electrolyte from being ignited even if spark is generated, when the internal pressure of a battery increases.

Patent Literature 4 discloses a current shut-off mechanism including two connector plates each having a center-through disk shape connected to each other at the inner circumferential end portions thereof, in which a thermally expandable resin is provided between the two connector plates in the inner circumferential side thereof, and a non-expandable resin is provided in the outer circumferential side of the thermally expandable resin. Patent Literature 4 intends to shut off the current immediately when a battery abnormally generates heat.

### CITATION LIST

### Patent Literature

[PTL 1] Japanese Laid-Open Patent Publication No. H7-254401
[PTL 2] Japanese Laid-Open Patent Publication No. H6-215760
[PTL 3] Japanese Laid-Open Patent Publication No. H10-321213
[PTL 4] Japanese Laid-Open Patent Publication No. 2007-194069

### SUMMARY OF INVENTION

### Technical Problem

The techniques disclosed in Patent Literatures 1 to 3 intend to stop discharging when the internal voltage in the battery is increased. However, for example, in a high capacity battery used as a power source for electric vehicles and the like, there is a possibility that the battery temperature is increased before the battery internal pressure is increased. Furthermore, when the battery temperature is increased in a short period of time, the gasket used for sealing the battery deteriorates, to allow the gas generated inside the battery to escape outside. Therefore, if the techniques disclosed in Patent Literatures 1 to 3 are applied to such a battery as that temperature is supposed to increase before the internal pressure thereof is increased, discharging cannot be always stopped sufficiently.

According to the technique disclosed in Patent Literature 4, the two connector plates disposed on both sides in the thickness direction of the thermally expandable resin are merely in line contact with each other. Because of this, as shown in Table 1 of Patent Literature 4, the resistance value between the two connector plates is very high, being as much as 0.04Ω.

For example, batteries used as a power source for electric vehicles and the like are required to have high output performance. In order to achieve high output performance, the internal resistance of the battery must be reduced as small as possible.

However, in the battery disclosed in Patent Literature 4, since the resistance value between the two connector plates is very high as described above, the internal resistance of the battery is considered very high. In other words, the battery disclosed in Patent Literature 4 is considered unlikely to function sufficiently not only as a power source for electric vehicles and the like but also as a power source for home appliances.

In view of the above, the present invention intends to reliably stop charging and discharging in a battery particularly with high capacity and high output performance, when a trouble occurs in the battery.

### Solution to Problem

According to one aspect of the present invention, an assembled sealing member for a battery to seal a battery case accommodating a power generation element includes:

(i) an electrically conductive cap having an external terminal;

(ii) an electrically conductive film being disposed so as to face the power generation element and connected to one of electrodes included in the power generation element;

(iii) an electrically conductive valving member disposed between the cap and the electrically conductive film; and

(iv) a thermally expandable material disposed between the valving member and the electrically conductive film. The electrically conductive film and the valving member are bonded to each other in an electrically connected state at at least one predetermined point, and when the thermally expandable material is expanded to be predetermined times larger, the bond between the electrically conductive film and the valving member ruptures to break the electrical connection between the electrically conductive film and the valving member.

According to another aspect of the present invention, a battery includes a power generation element, a battery case accommodating the power generation element, and the above-described assembled sealing member to seal an opening of the battery case.

### Effects of Invention

In one aspect of the present invention, since the electrically conductive film and the valving member are metallically bonded to each other at least one predetermined point, the electrically conductive film and the valving member are connected at low resistance. As such, for example, the high output performance can be maintained. Further, since the thermally expandable material is disposed between the electrically conductive film and the valving member, the electrically conductive film and the valving member bonded together are reliably separated from each other when the battery temperature is increased due to a trouble and the like. Therefore, according one aspect of to the present invention, particularly with respect to a battery with high capacity and high output performance, it is possible to detect an abnormality inside the battery, if any, to stop charging and discharging reliably. For example, according to one aspect of the present invention, when the battery temperature is increased before the battery internal pressure is increased, charging and discharging can be reliably stopped.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A longitudinal cross-sectional view schematically showing a battery according to one embodiment of the present invention.

FIG. 2 A longitudinal cross-sectional view schematically showing the positional relationship between the valving member and the electrically conductive film after the thermally expandable material has been expanded.

FIG. 3 An enlarged view of a portion indicated by a circle III in FIG. 2.

FIG. 4 A longitudinal cross-sectional view schematically showing an assembled sealing member included in a battery according to another embodiment of the present invention.

FIG. 5 A longitudinal cross-sectional view schematically showing a battery fabricated in Comparative Example.

### DESCRIPTION OF EMBODIMENT

A battery according to one embodiment of the present invention includes a power generation element, a battery case accommodating the power generation element, and an assembled sealing member to seal an opening of the battery case. The assembled sealing member includes (i) an electrically conductive cap having an external terminal; (ii) an electrically conductive film being disposed so as to face the power generation element and connected to one of electrodes included in the power generation element; (iii) an electrically conductive valving member disposed between the cap and the electrically conductive film; and (iv) a thermally expandable material disposed between the valving member and the electrically conductive film. The electrically conductive film and the valving member are bonded to each other in an electrically connected state at least one predetermined point, and when the thermally expandable material is expanded to be predetermined times larger, the bond between the electrically conductive film and the valving member ruptures to break the electrical connection between the electrically conductive film and the valving member.

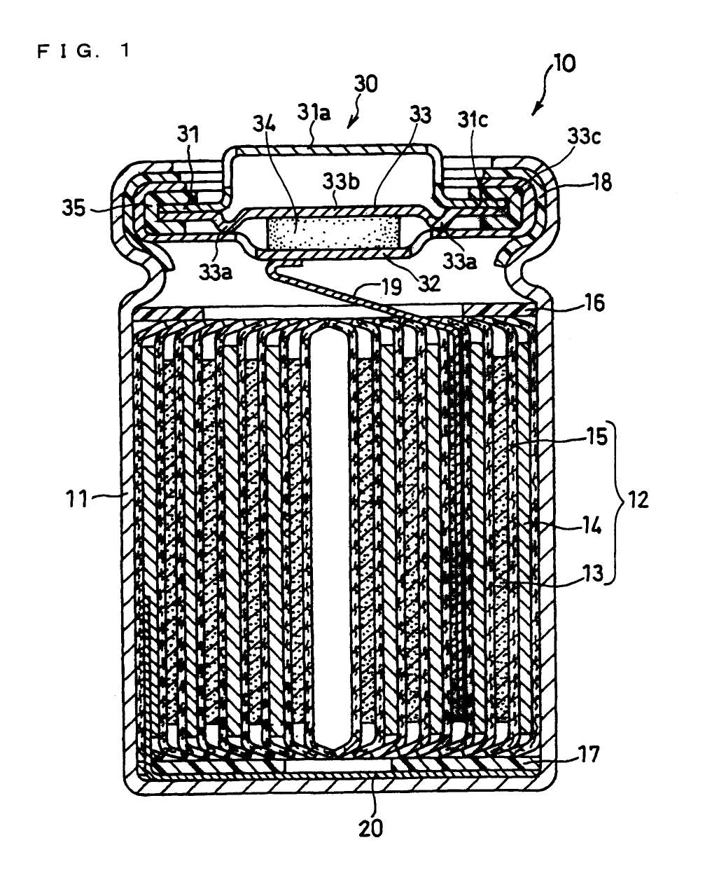

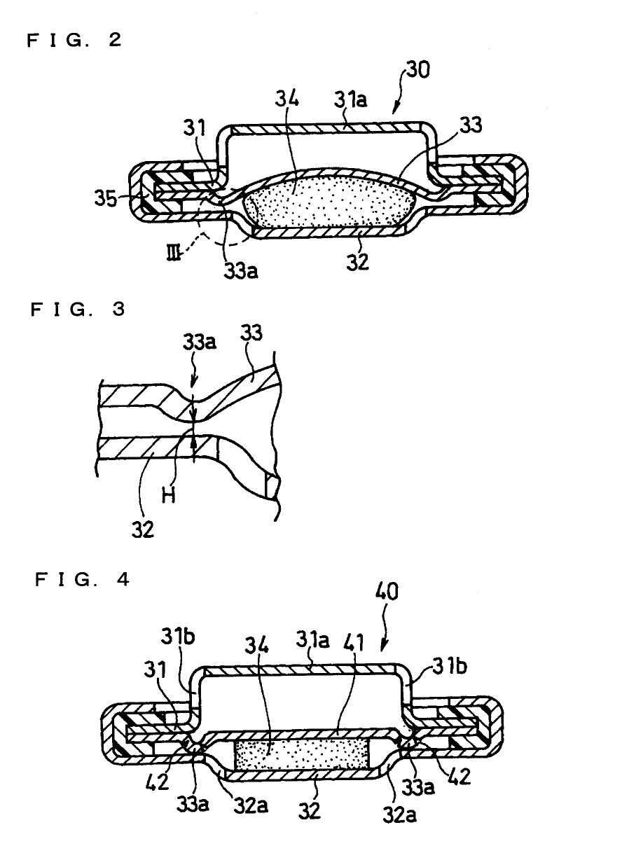

The battery according to this embodiment is described hereinafter with reference to FIGS. 1 to 3. FIG. 1 shows a longitudinal cross-sectional view of a battery according to one embodiment of the present invention. FIG. 2 schematically shows the positional relationship between the valving member and the electrically conductive film after the thermally expandable material has been expanded. FIG. 3 shows an enlarged view of a portion indicated by a circle III in FIG. 2. In FIGS. 1 to 3, the same components are denoted by the same reference numerals. For simplicity, only the assembled sealing member is illustrated in FIG. 2.

A hermetically sealed cylindrical battery 10 of FIG. 1 includes a battery case 11, a power generation element 12 accommodated in the cylindrical battery case 11, and an assembled sealing member 30. The power generation element 12 includes a first electrode 13, a second electrode 14, a separator 15 interposed between the first electrode 13 and the second electrode 14, and an electrolyte (not shown). It should be noted that in this embodiment, the first electrode 13 and the second electrode 14 may serve as a positive electrode and a negative electrode, respectively; or alternatively, the first electrode 13 and the second electrode 14 may serve as a negative electrode and a positive electrode, respectively.

The power generation element 12 is arranged in the interior of the battery case 11. A lower insulating plate 17 is arranged between the power generation element 12 and the inner bottom surface of the battery case 11, and an upper insulating plate 16 is arranged on top of the power generation element 12.

In the battery 10 of FIG. 1, the opening of the battery case 11 is sealed by an assembled sealing member 30. Specifically, the opening end of the battery case 11 is crimped onto the periphery of the assembled sealing member 30 with an insulating gasket 18 interposed therebetween, whereby the opening of the battery case 11 is sealed.

The assembled sealing member 30 includes (i) an electrically conductive cap 31 having an external terminal 31a, (ii) an electrically conductive film 32, (iii) an electrically conducive valving member 33 disposed between the cap 31 and the electrically conductive film 32, and (iv) a thermally expandable material 34 disposed between the valving member 33 and the electrically conductive film 32. The electrically conductive film 32 is disposed opposite to the cap 31, in other words, disposed so as to face the power generation element 12. The cap 31 and the valving member 33 are made of, for example, an electrically conductive film-like material. The thermally expandable material 34 expands when heated over the normal operation temperature range of a battery. The normal operation temperature range of a battery is, for example, −30° C. to 60° C.

In the assembled sealing member 30, a flat portion 31c is provided on the periphery of the cap 31, and a flat portion 33c is provided on the periphery of the valving member 33. The flat portion 31c of the cap 31 and the flat portion 33c of the valving member 33 are laminated together, providing electrical connection between the cap 31 and the valving member 33. An insulating layer 35 is provided so as to cover the laminated peripheral portions of the cap 31 and the valving member 33.

The electrically conductive film 32 (hereinafter referred to as the “conductive lower film 32”) and the valving member 33 are, for example, partially metallically bonded to each other at least one predetermined point. Specifically, for example, the valving member 33 has a protruding portion 33a being arranged so as to surround a center portion 33b of the valving member 33 and protruding toward the conductive lower film 32. The top of the protruding portion 33a is, for example, partially metallically bonded to the conductive lower film 32. Consequently, the conductive lower film 32 is electrically connected to the valving member 33, and thus the conductive lower film 32 is electrically connected to the cap 31.

The periphery of the conductive lower film 32 is crimped onto the periphery of a stack of the cap 31 and the valving member 33 with the insulating layer 35 interposed therebetween. As such, when the bond between the protruding portion 33a of the valving member 33 and the conductive lower film 32 is broken, the conductive lower film 32 and the valving member 33 are electrically disconnected from each other. The number of the protruding portions 33a of the valving member 33 and the bonding area between the conductive lower film 32 and the valving member 33 are suitably selected according to the use of the battery, the thickness and material of the conductive lower film 32 and the valving member 33, and other factors.

The valving member 33 may have a plurality of the protruding portions 33a which are separated from one another, or alternatively, the valving member 33 may be provided with the protruding portion 33a formed continuously along a predetermined circle. Specifically, the valving member 33 may have a protruding portion being formed continuously along a predetermined circle so as to surround the thermally expandable material 34 and protruding toward the conductive lower film 32. In this configuration, the protruding portion is bonded to the conductive lower film 32. The protruding portion may be partially bonded to the conductive lower film 32, or alternatively, the protruding portion may be totally bonded to the conductive lower film 32. Alternatively, the valving member 33 may have at least one separate protruding portion being formed along a predetermined circle so as to surround the thermally expandable material 34 and protruding toward the conductive lower film 32. In this configuration, some of or all of the at least one separate protruding portion may be bonded to the conductive lower film 32.

One end of a first lead 19 is connected to the first electrode 13, and the other end of the first lead 19 is connected to the surface of the conductive lower film 32 in the assembled sealing member 30 in the power generation element 12 side. One end of a second lead 20 is connected to the second electrode 14, and the other end of the second lead is connected to the inner bottom surface of the battery case 11.

The thermally expandable material 34 is arranged between the conductive lower film 32 and the valving member 33. In the assembled sealing member 30 shown in FIG. 1, the thermally expandable material 34 is disposed more inward in the radial direction of the battery 10 than the protruding portion 33a of the valving member 33. In other words, the thermally expandable material 34 faces the center portion 33b of the valving member 33 and is surrounded by the protruding portion 33a formed continuously. When the expandable material 34 is expanded to be predetermined times larger, the valving member 33 is pushed upward toward the cap 31 or the conductive lower film 32 is pushed downward, and as a result, the protruding portion 33a of the valving member 33 is separated from the conductive lower film 32 as shown in FIG. 2. This can prevent current from flowing from the conductive lower film 32 to the valving member 33. In short, the current can be shut off in response to an increase in battery temperature.

Since the conductive lower film 32 and the valving member 33 are metallically bonded to each other at least one predetermined point as described above, the conductive lower film 32 and the valving member 33 can be connected at low resistance. As such, for example, the high output performance can be maintained. Further, since the thermally expandable material 34 is disposed between the conductive lower film 32 and the valving member 33, the conductive lower film 32 and the valving member 33 metallically bonded together are reliably separated from each other when the battery temperature is increased due to a trouble and the like. Therefore, according to the configuration as described above, particularly with respect to a battery with high capacity and high output performance, it is possible to detect an abnormality inside the battery, if any, to stop charging and discharging reliably. For example, according to the configuration as described above, charging and discharging can be reliably stopped upon an increase in the battery temperature.

Preferably, the expansion coefficient of the thermally expandable material 34 reaches a maximum at 120° C. or higher. More preferably, the expansion coefficient at 120° C. of the thermally expandable material 34 is 200 to 400%. By the above, charging and discharging of the battery can be stopped reliably. In addition, even when the battery is in a high voltage state, it is possible, after the conductive lower film 32 and the valving member 33 are separated from each other, to reliably prevent a spark from occurring between the portions where the conductive lower film 32 and the valving member 33 have been bonded to each other.

The temperature at normal operation of high capacity batteries used as a power source for electric vehicles is 80° C. or lower. When a trouble occurs in such batteries, the battery temperature is increased and exceeds 80° C. Accordingly, by using the thermally expandable material 34 that reaches a maximum at a temperature sufficiently higher than 80° C., namely, at 120° C. or higher, discharging can be more reliably stopped only when a trouble occurs in the batteries. It should be noted that the thermally expandable material 34 preferably starts expanding at 120° C. or higher.

The thermally expandable material 34 satisfying the properties as described above may be an expandable inorganic material such as expandable graphite and vermiculite. Among these, expandable graphite is preferred. Expandable graphite starts expanding at about 120° C. and, therefore, is the most suitable for the above use.

Expandable graphite is a graphite interlayer compound obtained by chemical treatment of graphite (e.g., natural flake graphite or pyrolytic graphite) with an inorganic acid (e.g., sulfuric acid or nitric acid) and a strongly oxidizing agent (e.g., perchlorate, permanganate, or dichromate).

The thermally expandable material 34 may contain, as needed, an electrically insulating resin material or the like, in addition to the expandable inorganic material.

Examples of the resin material include rubber materials, polyurethane resins, polyolefin resins, epoxy resins, acrylonitrile-butadiene-styrene (ABS) resins, polycarbonate resins, acrylic resins, polyamide resins, polyamide-imide resins, and phenol resins. Rubber materials are exemplified by chloroprene rubbers, isoprene rubbers, styrene-butadiene rubbers, acrylic rubbers, and natural rubbers.

Polyolefin resins are exemplified by polyethylene resins and polypropylene resins.

When the thermally expandable material contains an expandable inorganic material and a resin material or the like, the amount of the expandable inorganic material is not particularly limited as long as the conductive lower film 32 and the valving member 33 are reliably separated from each other. The amount of the expandable inorganic material is preferably 1 to 90% by weight in the thermally expandable material, and more preferably 5 to 50% by weight.

Further, when the thermally expandable material contains an expandable inorganic material and a resin material or the like, the expansion coefficient of the thermally expandable material can be controlled by adjusting the amount of the expandable inorganic material.

The expansion coefficient at 120° C. of the thermally expandable material can be calculated by

[(thickness at 120° C.)/(thickness in unexpanded condition)]×100.

Here, the thickness in unexpanded condition is a thickness of the thermally expandable material placed between the valving member and the conductive lower film, at a temperature sufficiently lower than a temperature at which expansion starts (e.g., the thickness at 25° C.).

When the battery temperature is increased to 120° C. or higher, that is, the thermally expandable material 34 is heated to 120° C. or higher, the thermally expandable material 34 expands, and the conductive lower film 32 and the valving member 33 metallically bonded together are separated from each other. At this time, as shown in FIG. 3, at the point where the conductive lower film 32 and the valving member 33 have been metallically bonded together, that is, at the point where the conductive lower film 32 and the valving member 33 are closest to each other, the distance H between the conductive lower film 32 and the valving member 33 is preferably 0.4 mm or more and more preferably 1 mm or more. The distance H between the conductive lower film 32 and the valving member 33 is a distance therebetween at the point where the conductive lower film 32 and the valving member 33 have been bonded to each other, measured as the length of a perpendicular between a closest point to the valving member 33 on the conductive lower film 32 and a closest point to the conductive lower film 32 on the protruding portion 33a of the valving member 33.

Particularly in the case of a battery in a high voltage state, if the distance between the conductive lower film 32 and the valving member 33 is small at the point where the conductive lower film 32 and the valving member 33 are closest to each other, there is a possibility that spark is generated between the conductive lower film 32 and the valving member 33. However, by setting the distance H between the conductive lower film 32 and the valving member 33 at the point where the conductive lower film 32 and the valving member 33 are closest to each other to 0.4 mm or more, it is possible to prevent spark from being generated between the conductive lower film 32 and the valving member 33. In addition, even when the battery voltage is as high as 50 V, as long as the distance H is 0.4 mm or more, the generation of spark can be prevented.

The distance H between the conductive lower film 32 and the valving member 33 after the thermally expandable material 34 has been expanded can be controlled by adjusting the thickness of the thermally expandable material before thermal expansion, the expansion coefficient at 120° C. of the thermally expandable material.

The thickness of the thermally expandable material 34 arranged between the conductive lower film 32 and the valving member 33 is suitably selected according to, for example, the shape of the conductive lower film 32 and the valving member 33.

The cap 31 and the valving member 33 are made of, for example, an electrically conductive film-like material such as a metal foil. Specifically, the cap 31 is preferably made of a Ni-plated cold rolled steel sheet (e.g., SPCC or SPCD) or a stainless steel.

The valving member 33 is preferably made of, for example, an aluminum (e.g., 1N50 or A1050 aluminum) or an aluminum alloy (e.g., 3000 series aluminum alloys such as 3003 aluminum alloy).

The electrically conductive film (the conductive lower film) 32 is preferably made of, for example, an aluminum alloy (e.g., 5052 or 3003 aluminum alloy).

The insulating layer 35 may be made of, for example, polypropylene (PP), polyphenylene sulfide (PPS), or tetrafluoroethylene-perfluorovinylether copolymer (PFA).

The thickness of an electrically conductive film-like material forming the cap 31 is preferably 0.4 to 1 mm. The thickness of the electrically conductive film (the conductive lower film) 32 is preferably 0.4 to 1 mm. The thickness of an electrically conductive film-like material forming the valving member 33 is preferably 0.2 to 0.5 mm.

The thickness of the insulating layer 35 is not particularly limited, but is sufficient if it is 0.5 or 1 mm.

Further, as shown in FIG. 1, the first lead 19 made of metal is preferably connected to the conductive lower film 32 at a portion on the surface thereof opposite to the surface on which the thermally expandable material 34 is disposed, the portion facing the thermally expandable material 34. In short, the connected portion between the first lead 19 and the conductive lower film 32 faces the thermally expandable material 34 with the conductive lower film 32 interposed therebetween.

When a trouble such as short circuiting occurs in the power generation element 12, the temperature of the power generation element 12 is increased. The heat generated is usually conducted faster through metals than though the gaseous atmosphere in the battery. That is, the heat generated in the power generation element 12 tends to be conducted through the first lead 19 made of metal. As such, by connecting the first lead 19 to the conductive lower film 32 at a portion on the surface thereof opposite to the surface on which the thermally expandable material 34 is disposed, the portion facing the thermally expandable material 34, the heat generated in the power generation element 12 can be rapidly conducted to the thermally expandable material 34. As a result, charging and discharging can be stopped reliably and immediately even when the battery temperature is abruptly increased.

Although depending on the type of a battery, in the case where the first electrode is a positive electrode, and the second electrode is a negative electrode, the first lead 19 may be made of, for example, aluminum or titanium, and the second lead 20 may be made of, for example, copper or nickel.

The safety mechanism provided in the assembled sealing member may be designed to be activated by an increase in the internal pressure of the battery. In other words, it may be designed such that the current is shut off also when the internal pressure of the battery is increased. This is described below with reference to FIG. 4. In FIG. 4, the same components are denoted by the same reference numerals.

It is preferable in an assembled sealing member 40 shown in FIG. 4 that: the cap 31 has a through hole 31b through the cap 31 in the thickness direction thereof; the conductive lower film 32 has a through hole 32a through the conductive lower film 32 in the thickness direction thereof; and the protruding portion 33a of a valving member 41 is provided with a thin portion 42. The thin portion 42 is preferably provided in the protruding portion 33a such that the protruding portion 33a ruptures at the thin portion 42 upon an increase of the internal pressure of the battery, causing the conductive lower film 32 and the valving member 41 to be completely separated from each other.

By configuring as described above, when the battery temperature is increased and the battery internal pressure is increased, the thermally expandable material 34 expands and, depending on the extent to which the battery internal pressure is increased, the thin portion 42 ruptures. This makes it possible to more reliably separate the conductive lower film 32 and the valving member 41 from each other, as well as to allow the gas generated inside the battery to escape outside.

The thickness of the thin portion 42 is preferably in the range of 20% to 50% of the thickness of the valving member 41. For example, the thickness of the thin portion 42 may be 0.03 to 0.05 mm. When the thickness of the thin portion 42 is less than 20% of the thickness of the valving member 41, it is difficult to form the thin portion 42. When the thickness of the thin portion 42 is more than 50% of the thickness of the valving member 41, the thin portion 42 is unlikely to rupture upon an increase in the battery internal pressure. Here, the thickness of the valving member is the thickness of a metal foil forming the valving member.

Alternatively, the commonly used mechanism for shutting off the current when the battery internal pressure is increased may be used in combination with the current shut-off mechanism as shown in FIG. 1.

In the case where the thermally expandable material contains expandable graphite, a heat-resistant electrically insulating sheet may be disposed at a portion in contact with the thermally expandable material of the valving member.

The resistance of the expanded expandable graphite is predicted to reach several ten Ω, and because of this, the current is considered to be sufficiently shut off when the bond between the valving member and the conductive lower film ruptures, even though the valving member, the thermally expandable material containing expandable graphite, and the conductive lower film are in direct contact with one another.

By further disposing the heat-resistant insulating sheet at a portion on the valving member that contacts with the thermally expandable material, the electrical insulation between the thermally expandable material and the valving member can be enhanced. As a result, the current shut-off function in the case where the thermally expandable material contains expandable graphite can be improved.

The heat-resistant insulating sheet may be made of, for example, polyamide, polyimide, polyamide-imide, polyetherimide, or polyether ether ketone.

The thickness of the heat-resistant insulating sheet is not particularly limited, as long as the valving member and the thermally expandable material can be insulated from each other.

The components other than the assembled sealing member 30 are described below with reference to FIG. 1 again, assuming that the first electrode 13 is a positive electrode and the second electrode 14 is a negative electrode.

The positive electrode may include, for example, a positive electrode current collector, and a positive electrode active material layer formed on the positive electrode current collector. The positive electrode active material layer may include a positive electrode active material, and as needed, a binder, a conductive agent, and the like.

The positive electrode active material is suitably selected according to the type of a battery to be produced. When a lithium battery is to be produced, for example, a lithium-containing transition metal composite oxide such as lithium cobalt oxide (LiCoO₂), lithium nickel oxide (LiNiO₂), and lithium manganese oxide (LiMn₂O₄), or manganese dioxide may be used as the positive electrode active material.

When an alkaline storage battery is to be produced, for example, nickel hydroxide may be used as the positive electrode active material. A sintered nickel positive electrode known in the field may also be used.

Examples of the binder to be added in the positive electrode include polytetrafluoroethylene and polyvinylidene fluoride.

Examples of the conductive agent to be added in the positive electrode include graphites such as natural graphite (e.g., flake graphite), artificial graphite, and expandable graphite; carbon blacks such as acetylene black, Ketjen black, channel black, furnace black, lamp black, and thermal black; conductive fibers such as carbon fibers and metal fibers; metal powders such as copper power and nickel powder; and organic conductive materials such as polyphenylene derivatives.

The positive electrode current collector may be made of, for example, aluminum, an aluminum alloy, nickel, or titanium.

The negative electrode may include, for example, a negative electrode current collector, and a negative electrode active material layer formed on the negative electrode current collector. The negative electrode active material layer may include a negative electrode active material, and as needed, a binder, a conductive agent, and the like.

The negative electrode active material is suitably selected according to the type of a battery to be produced.

When a lithium battery is to be produced, for example, metallic lithium, a lithium alloy, a carbon material such as graphite, elementary silicon, a silicon alloy, a silicon oxide, tin, a tin alloy, or a tin oxide may be used as the negative electrode active material.

When an alkaline storage battery is to be produced, for example, a metal hydride known in the field may be used as the negative electrode active material.

Examples of the binder and the conductive agent to be added in the negative electrode are the same as those to be added in the positive electrode.

The negative electrode current collector may be made of, for example, stainless steel, nickel, or copper.

The electrolyte is suitably selected according to the type of a battery to be produced. When a lithium battery is to be produced, a non-aqueous electrolyte is used as the electrolyte. The non-aqueous electrolyte contains a non-aqueous solvent, and a solute dissolving therein.

Examples of the non-aqueous solvent include ethylene carbonate, propylene carbonate, dimethyl carbonate, diethyl carbonate, and ethyl methyl carbonate. These non-aqueous solvents may be used singly or in combination of two or more.

Examples of the solute include LiPF₆, LiBF₄, LiCl₄, LiAlCl₄, LiSbF₆, LiSCN, LiCl, LiCF₃SO₃, LiCF₃CO₂, LiAsF₆, LiN(CF₃SO₂)₂, LiB₁₀Cl₁₀, and imides. These may be used singly or in combination of two or more.

When an alkaline storage battery is to be produced, an alkaline electrolyte may be used as the electrolyte. The alkaline electrolyte may contain an aqueous potassium hydroxide solution having a specific gravity of 1.30 and lithium hydroxide dissolving therein at a concentration of 40 g/L.

The separator 15 may be made of any material known in the field that can provide electrical insulation between the first electrode (positive electrode) 13 and the second electrode (negative electrode) 14 and is chemically stable in the battery. Examples of the above material include polyethylene, polypropylene, a mixture of polyethylene and polypropylene, and a copolymer of ethylene and propylene.

The battery case 11 may be made of, for example, a Ni-plated steel sheet, or stainless steel.

The present invention is particularly effective for a battery having a nominal capacity of 4 Ah or more. As described above, in a high capacity battery, there is a possibility that the battery temperature is increased before the battery internal pressure is increased, when a trouble such as short circuiting occurs. If the battery temperature is increased abruptly, the insulating gasket used for sealing the battery may deteriorate to allow the gas generated inside the battery to escape outside. Therefore, in the conventional battery designed such that the current is shut off when the internal pressure of the battery is increased, discharging cannot be stopped sufficiently when a trouble such as short circuiting occurs. In contrast, in the present invention, the current is shut off when the thermally expandable material is expanded. Therefore, according to the present invention, charging and discharging can be reliably stopped particularly in a battery with high capacity and high output performance, even when an abnormality occurs inside the battery.

Further, in the case where a battery including the assembled sealing member 30 as described above is used as a power source for electric vehicles and the like, the resistance value of the assembled sealing member 30 is preferably 1 mΩ or less so that the battery can have high output performance.

The resistance value of the assembled sealing member 30 can be measured by using, for example, a four-point terminal method. Specifically, a predetermined value of current is allowed to flow across the cap 31 and the conductive lower film 32, to measure the voltage between the cap 31 and the conductive lower film 32. The resistance value of the assembled sealing member 30 can be determined from the above current value and the measured voltage value.

The resistance value of the assembled sealing member 30 can be controlled by selecting, for example, the bonding area between the conductive lower film 32 and the valving member 33, or the materials forming the cap 31, the conductive lower film 32, and the valving member 33.

In particular, lithium secondary batteries have a high voltage and a high capacity. Because of this, when a trouble occurs in lithium secondary batteries, there is a risk that the battery temperature may be increased abruptly. By applying the present invention to lithium secondary batteries, the safety of the lithium secondary batteries can be further improved.

### EXAMPLES

### Example 1

A sealed cylindrical battery as shown for FIG. 1 was fabricated.

### (1) Production of Positive Electrode Plate

Lithium cobalt oxide (LiCoO₂) was used as a positive electrode active material. The positive electrode active material was mixed in an amount of 85 parts by weight with 10 parts by weight of carbon powder serving as a conductive agent and a N-methyl-2-pyrrolidone (hereinafter referred to as “NMP”) solution containing polyvinylidene fluoride (hereinafter referred to as “PVDF”) serving as a binder, to prepare a positive electrode material mixture paste. The amount of the added PVDF was 5 parts by weight.

The positive electrode material mixture paste thus prepared was applied onto both surfaces of a current collector made of a 15-μm-thick aluminum foil, dried and rolled, to give a positive electrode plate having a thickness of 100 μm.

### (2) Production of Negative Electrode Plate

Artificial graphite powder serving as a negative electrode active material was mixed in an amount of 95 parts by weight with an NMP solution containing PVDF serving as a binder, to prepare a negative electrode material mixture paste. The amount of the added PVDF was 5 parts by weight.

The negative electrode material mixture paste thus prepared was applied onto both surfaces of a current collector made of a 10-μm-thick copper foil, dried and rolled, to give a negative electrode plate having a thickness of 100 μm.

### (3) Preparation of Non-Aqueous Electrolyte

Lithium hexafluorophosphate (LiPF₆) was dissolved at a concentration of 1.5 mol/L in a mixed solvent containing ethylene carbonate, ethyl methyl carbonate, and dimethyl carbonate in a ratio of 1:1:8 by volume, to prepare a non-aqueous electrolyte.

### (4) Production of Assembled Sealing Member

An assembled sealing member as shown in FIG. 1 was produced. Expandable graphite (expansion coefficient at 120° C.: 200%) was used as a thermally expandable material.

First, a predetermined metal foil was pressed to form a cap, a conductive lower film, and a valving member. The valving member was provided with a protruding portion formed continuously along a predetermined circle. Only in this Example 1, a heat-resistant resin sheet was disposed on the valving member at a portion predicted to contact with the expanded expandable graphite. It should be noted that since the resistance of the expanded expandable graphite is high, the current can be shut off without the heat-resistant resin sheet, upon rupture of the bond between the valving member and the conductive lower film.

Next, a thermally expandable material was disposed on a surface of the conductive lower film facing the valving member. The thermally expandable material was disposed so as to be positioned within a circle defined by the protruding portion of the valving member in a subsequent process of bonding the conductive lower film and the valving member together.

The protruding portion of the valving member and the conductive lower film were resistance-welded to bond the valving member and the conductive lower film together. The welding area between the valving member and the conductive lower film was 1.5 mm² or more.

Subsequently, the cap was stacked on the valving member on the side opposite to the side being in contact with the conductive lower film. The periphery of the conductive lower film was crimped onto the periphery of the stack of the cap and the valving member with an insulating layer interposed therebetween so as to cover the periphery of the stack, to give an assembled sealing member.

The thicknesses of the cap, the valving member, and the conductive lower film were 0.5 mm, 0.4 mm, and 0.5 mm, respectively. Here, the thickness of each component is the thickness of a metal foil forming the component.

### (5) Fabrication of Sealed Battery

The positive electrode plate and the negative electrode plate obtained were laminated with a 25-μm-thick separator interposed therebetween, to give a laminate. The laminate was wound into a coil, to form a cylindrical electrode group.

The electrode group obtained was placed together with 28 mL of the above prepared non-aqueous electrolyte in a bottomed nickel-plated iron case of 29 mmØ in inner diameter. The thickness of the nickel-plated iron foil was 0.4 mm.

One end of a positive electrode lead made of aluminum was connected to the positive electrode plate; and the other end of the positive electrode lead was connected to the conductive lower film in the assembled sealing member at a portion on the surface thereof opposite to the surface on which the thermally expandable material was disposed, the portion facing the thermally expandable material. One end of a negative electrode lead made of copper was connected to the negative electrode plate; and the other end of the negative electrode lead was connected to the inner bottom surface of the battery case. An upper insulating plate and a lower insulating plate were placed on the top and the bottom of the electrode group, respectively.

The opening end of the battery case was crimped onto the periphery of the assembled sealing member with an insulating gasket interposed therebetween, thereby to seal the opening of the battery case. A sealed battery was thus fabricated. The nominal capacity of the battery was 6800 mAh. The battery thus fabricated was referred to as Battery 1.

### Example 2

Battery 2 was fabricated in the same manner as in Example 1, except that 3M Fire Barrier (trade name, a sheet material made of a resin composition containing chloroprene rubber and vermiculite, expansion coefficient at 120° C.: 300%).

### Example 3

Battery 3 was fabricated in the same manner as in Example 1, except that mejihikatto available from Mitsui Kinzoku Paints & Chemicals Co., Ltd. (trade name, a sheet material made of a resin composition containing polyurethane resin and expandable graphite, expansion coefficient at 120° C.: 400%).

### Comparative Example 1

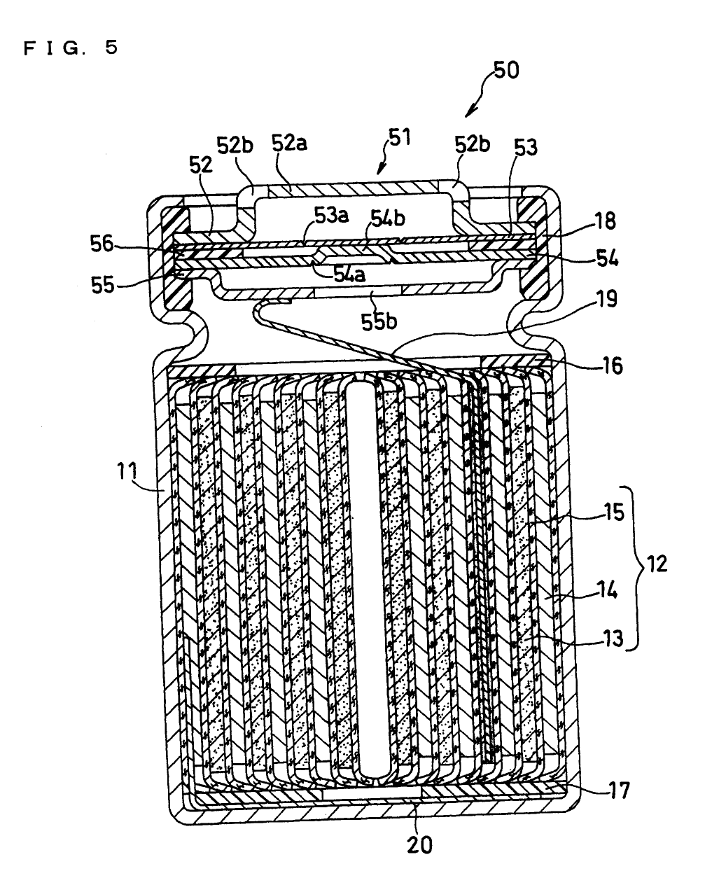

A sealed cylindrical battery 50 was fabricated in the same manner as in Example 1, except that a conventional assembled sealing member 51 as shown in FIG. 5 was used. The fabricated battery was referred to as Comparative Example 1. In FIG. 5, the same components as those in FIG. 1 are denoted by the same reference numerals, and the description thereof is omitted.

The assembled sealing member 51 includes a cap 52 having an external terminal 52a, an upper valving member 53, a lower valving member 54, and a conductive lower film 55. The upper valving member 53 is provided with a circular or “C”-shaped thin portion 53a. The lower valving member 54 is provided with a circular thin portion 54a. A protruding portion 54b protruding toward the upper valving member 53 is provided inside the circular thin portion 54a, and the protruding portion 54b is electrically connected to the upper valving member 53. Between the upper valving member 53 and the lower valving member 54, an insulating layer 56 is provided, and the upper valving member 53 is in contact with the lower valving member 54 at the protruding portion 54b only.

To the upper valving member 53, the cap 52 is connected; and to the lower valving member 54, the conductive lower film 55 is connected. The cap 52 is provided with a through hole 52b through the cap 52 in the thickness direction thereof; and the conductive lower film 55 is provided with a through hole 55b through the conductive lower film 55 in the thickness direction thereof.

In the battery 50, when gas is generated inside the battery, the battery internal pressure is increased. The generated gas passes through the through hole 55b in the conductive lower film 55 and enters inside the assembled sealing member 51, to push up the lower valving member 54. When the lower valving member 54 is pushed up, the thin portion 54a of the lower valving member 54 ruptures to cause the upper valving member 53 and the lower valving member 54 to separate from each other. As a result, the current is shut off in the battery.

There is a possibility that the battery internal pressure is further increased even after the current is shut off. When this happens, the thin portion 53a of the upper valving member 53 ruptures, to allow the gas generated inside the battery to escape outside through the through hole 52b in the cap 52.

### [Evaluation]

Batteries 1 to 3 and Comparative Battery 1 were subjected to a heating test as described below.

Each battery was charged at a current of 6.8 A (1 C), during which heat was applied around the assembled sealing member.

As a result, in Batteries 1 to 3, charging was able to be stopped in the middle of charging. On the other hand, in Comparative Battery 1, charging was not able to be stopped.

From the results above, it is clear that using an assembled sealing member in which a thermally expandable material is disposed between the valving member and the conductive lower film, charging and discharging can be stopped reliably when the battery temperature is increased upon occurrence of a trouble or other events.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The battery using the assembled sealing member as described above has further improved safety and therefore is suitably applicable as a driving power source for portable electronic devices such as cellular phones, notebook personal computers, and video camcorders. Further, the battery is also suitably applicable as a power source for hybrid electric vehicles, plug-in hybrid electric vehicles, electricity-powered bicycles, and the like.

### REFERENCE SIGNS LIST

10 Battery
11 Battery case
12 Power generation element
13 First electrode
14 Second electrode
15 Separator
16 Upper insulating plate
17 Lower insulating plate
18 Insulating gasket
19 First lead
20 Second lead
30, 40 Assembled sealing member
31 Cap
31a External terminal
32 Electrically conductive film
31b, 32a Through hole
33, 41 Valving member
33a Protruding portion
33b Center portion of valving member
31c, 33c Flat portion on periphery of valving member
34 Thermally expandable material
35 Insulating layer
42 Thin portion of valving member

1. An assembled sealing member for a battery to seal a battery case accommodating a power generation element, the assembled sealing member comprising:
(i) an electrically conductive cap having an external terminal;
(ii) an electrically conductive film being disposed so as to face the power generation element and connected to one of electrodes included in the power generation element;
(iii) a valving member disposed between the cap and the electrically conductive film; and
(iv) a thermally expandable material disposed between the valving member and the electrically conductive film; wherein
the electrically conductive film and the valving member are bonded to each other in an electrically connected state at least one predetermined point, and when the thermally expandable material is expanded to be predetermined times larger, the bond between the electrically conductive film and the valving member ruptures to break the electrical connection between the electrically conductive film and the valving member.

2. The assembled sealing member for a battery in accordance with claim 1, wherein the valving member has a protruding portion being formed continuously along a predetermined circle so as to surround the thermally expandable material and protruding toward the electrically conductive film, and the electrically conductive film and the protruding portion are bonded to each other.

3. The assembled sealing member for a battery in accordance with claim 1, wherein the valving member has a plurality of protruding portions being separated from each other and being formed along a predetermined circle so as to surround the thermally expandable material and protruding toward the electrically conductive film, and the electrically conductive film and each of the protruding portions are bonded to each other.

4. The assembled sealing member for a battery in accordance with claim 1, wherein the expansion coefficient of the thermally expandable material reaches a maximum at 120° C. or higher.

5. The assembled sealing member for a battery in accordance with claim 4, wherein the expansion coefficient at 120° C. of the thermally expandable material is 200 to 400%.

6. The assembled sealing member for a battery in accordance with claim 1, wherein the thermally expandable material includes an expandable inorganic material.

7. The assembled sealing member for a battery in accordance with claim 6, wherein the expandable inorganic material comprises expandable graphite.

8. The assembled sealing member for a battery in accordance with claim 7, wherein a heat-resistant electrically insulating sheet is disposed at a portion of the valving member, the portion being in contact with the thermally expandable material.

9. The assembled sealing member for a battery in accordance with claim 1, wherein the thermally expandable material further comprises a resin material.

10. The assembled sealing member for a battery in accordance with claim 1, wherein when the thermally expandable material is heated to 120° C. or higher, the electrically conductive film and the valving member are separated from each other due to the expansion of the thermally expandable material by 0.4 mm or more at the point where the electrically conductive film and the valving member have been bonded to each other.

11. The assembled sealing member for a battery in accordance with claim 1, wherein:
the cap has a through hole through the cap in the thickness direction thereof;
the electrically conductive film has a through hole through the electrically conductive film in the thickness direction thereof; and
the valving member has a protruding portion protruding toward the electrically conductive film, the electrically conductive film and the protruding portion of the valving member are bonded to each other, and the protruding portion of the valving member is provided with a thin portion.

12. The assembled sealing member for a battery in accordance with claim 1, having a resistance value of 1 mΩ or less.

13. A battery comprising a power generation element, a battery case accommodating the power generation element, and the assembled sealing member of claim 1 to seal an opening of the battery case.

14. The battery in accordance with claim 13, wherein the power generation element has a first electrode, a second electrode, and a separator interposed between the first electrode and the second electrode, wherein
the first electrode and the electrically conductive film are electrically connected to each other by a first lead, and
the connected portion between the first lead and the electrically conductive film faces the thermally expandable material with the electrically conductive film interposed therebetween.

15. The battery in accordance with claim 13, having a nominal capacity of 4 Ah or more.
